(19) United States
(12) Patent Application Publication
(10) Pub. No.: US 2021/0264018 A1
(43) Pub. Date: Aug. 26, 2021

(54) SECURELY MANAGING AUTHENTICATED USER-DATA ITEMS

(71) Applicant: NewBanking ApS, Copenhagen (DK)

(72) Inventors: Morten HELLES, Copenhagen (DK); Christian Visti LARSEN, Kongens Lyngby (DK)

(21) Appl. No.: 17/254,816

(22) PCT Filed: Jun. 26, 2019
(86) PCT No.: PCT/EP2019/066974

§ 371 Date: Dec. 21, 2020

(30) Foreign Application Priority Data
Jun. 27, 2018 (DK) PA 2018 70445

(51) Int. Cl. G06F 21/45; H04L 29/06; G06F 21/62; H04L 9/32

(52) U.S. Cl. CPC G06F 21/45; H04L 63/102; G06F 21/62; G06Q 10/105; H04L 9/3239; G06F 2221/2137; H04L 2209/38; H04L 63/0823

(57) ABSTRACT

Disclosed is a system and a computer-implemented method for managing a verified digital identity of a user, the verified digital identity being implemented on a secure personal data sharing platform, the secure personal data sharing platform being a network accessible data structure, the secure personal data sharing platform being configured to be accessible by multiple parties; each of the multiple parties having access rights assigned upon second user request and second user consent. The method and system: receiving at the secure personal data sharing platform, a first user request to store a first user-data item in the verified digital identity; the first user request comprising a first user-data consent to receive and store the first user-data item as part of the verified digital identity on the secure personal data sharing platform; determining a verification status of the received first user-data item, the verification status for the first user-data item including un-verified user-data item or authenticated user data-item, wherein the status of authenticated user-data item is provided if the determined associated information confirms that the first user data-item is received from an authenticating party being certified for issuing the first user-data item.

### TECHNICAL FIELD

The present disclosure relates to systems, methods and computer program products for handling user data. In particular the present disclosure relates to systems, methods and computer program products for managing a verified digital identity of a user, including securely obtaining and controlling access to a verified digital identity of a user. The present disclosure thus ensures that a user's or customer's authenticated data items can be provided directly to a requesting institution while still allowing the user to control who has access to the authenticated customer data items.

### SUMMARY

Personal data, authenticated and verified documents are often needed by institutions to confirm the identity of a customer and/or the authenticity of customer information provided by the customer, for example in customer due diligence processes.

Onboarding and maintaining personal information of current or potential customers known as prospects is common practice as part of a Know Your Customer (KYC) process and many commercial institutions such as in the financial or insurance sector use some sort of platform and system. These require the prospect to supply for example personal data, identification documents, financial records, wage slips etc. and the institution must either trust the information provided on face value or use a verification process to determine the authenticity of the information or document. Alternatively, the customer may be asked to provide a certified copy of the information which can place a financial and a time cost on the customer as well as being possible to manipulate.

Currently, the most common method is where a potential customer or prospect must send the required data and information for each new service required and to each institution independently. Current onboarding procedures thus result in the prospect being required to send the same information to several different legal entities within the same organisation. Each different legal entity or institution requires a full and separate onboarding process. Current onboarding practices involve each separate legal entity collecting documents and face-to-face checking and/or individually engaging with reference agencies to verify customer identity against independent data sources. The customer must repeat the process of supplying data and information and wait on the legal entity to verify each piece of information. This process is then repeated for every institution and legal entity that the customer is or wishes to be engaged with and must personally keep an overview of what information is supplied to and stored with which institution. The process furthermore needs to be repeated when changes in personal information occurs to ensure that the data are updated.

A digital personal data sharing platform is available that solves many of the problems outlined above but currently requires the prospect to download a copy of the document or information required or make a copy of a document and store it on their personal device or system. This document must then either be taken to a notary public by the prospect to be certified or left in its downloaded or copied state and then forwarded to the institution that has requested the information or document. This has a number of disadvantages, the prospect must use time and perhaps money to copy the document and have it certified and then upload it to their digital personal data sharing platform profile. Or if it is a question of downloading then the prospect must spend time downloading the document, storing it on their personal device before uploading it to their digital personal data sharing platform profile. This is an inconvenience to the prospect.

A reduced level of data security may be experienced or needed. A downloaded version or a copy of the prospect's personal data must be stored on their personal device before it is uploaded to their digital personal data sharing platform profile. The prospect must ensure that the security protection of their device is of a high standard and must ensure that the personal information is deleted from their device in a secure manner to reduce the risk of accidental or unwanted access to it.

An institution who uses the information as part of their KYC process may have to determine if the prospect has manipulated the information or document in any way and that the document or information is authentic and a true copy of the original. In the case of a passport copy, an institution might use a third party verification company to verify the passport. Such a company does not have an original of the prospect's passport and will only use their automated check to determine if the passport is of a standard size, layout and conforms to the template of a typical passport from that country. It is possible to have a manipulated passport copy verified as ok by a third party verification company.

Some personal information may be temporary or may be subject to change. A driving license for example will have an expiry date. Further, documents such as a driving license, degree certificate or grade sheet, passport, license to practice law or medicine can all be withdrawn, revoked or invalidated before their date of expiry. In a case where the issuing authority revokes or invalidates the license, the institution would still have on record until the original date of expiry that the customer is in possession of a valid license.

Legislation and regulations, such as the current KYC and Anti Money Laundering (AML) regulations, require each legal entity holds accurate, verified and up to date data on each of their customers. In general several institutions need to have a high degree of certainty in that the information and data they hold on a customer is the correct and most up to date information.

Therefore, a renewed passport or change of address requires that the process is repeated to update the out of date information. The institution must identify that a piece of information is out of date, it must then instruct the customer to supply and up to date version of the information, then on receiving the information it must verify it and update its systems and discard all copies of the out of date information.

A European Anti Money Laundering Directive, 4^{th} AML, came into effect in 2015. In 2018 a pan European General Data Protection Regulation, GDPR, will come into force. Both of these pieces of legislation increase the burden on commercial institutions to have a complete knowledge and control over customer personal data as well as unambiguous customer consent before sharing or processing their data.

Thus there is a need for more efficient systems and methods for securely obtaining and controlling access to a verified digital identity of a user. There is a need to e.g. obtaining and handling authenticated user data in connection to e.g. onboarding procedures and when creating and maintaining verified digital identities.

According to some embodiments, a computer-implemented method for managing a verified digital identity of a user is provided. The verified digital identity comprising user-data encoded as user-data items, the verified digital identity being implemented on a secure personal data sharing platform, the secure personal data sharing platform being a network accessible data structure, the secure personal data sharing platform being configured to be accessible by multiple parties; each of the multiple parties having access rights assigned upon second user request and second user consent. The method may comprise receiving at the secure personal data sharing platform, a first user request to store a first user-data item in the verified digital identity; the first user request comprising a first user-data consent to receive and store the first user-data item as part of the verified digital identity on the secure personal data sharing platform. The method may further comprise in response to receiving the first user request: receiving the first user-data item at the secure personal data sharing platform and optional transmission information for the first user-data item. The method may further comprise processing the first user-data item and optionally the transmission information to determine associated information of the first user-data item. The associated information may comprise one or more of sender information, information of certificates and information on encryption and decryption. The first user-data item and the associated information may be stored on the secure personal data sharing platform as part of the verified digital identity. The associated information may determine a verification status of the received first user-data item, the verification status for the first user-data item including un-verified user-data item or authenticated user data-item. The status of authenticated user-data item may be provided if the determined associated information confirms that the first user data-item is received from an authenticating party being certified for issuing the first user-data item. Access to the user-data items on the secure personal data sharing platform may be enabled for third parties upon second user consent; the third parties being informed of the user-data item verification status.

According to some embodiments, a computer system for managing a verified digital identity of a user is provided. The system comprising a processor, such as a hardware processor, a computer readable storage medium, such as a non-transitionary computer readable storage medium, storing a computer program product comprising instructions which when executed by the processor provides a secure personal data sharing platform, the secure personal data sharing platform being a network accessible data structure. The secure personal data sharing platform may be configured to be accessible by multiple parties; each of the multiple parties having access rights assigned upon second user request and second user consent; and provides a verified digital identity comprising user-data encoded as user-data items. The verified digital identity is implemented on the secure personal data sharing platform. The secure personal data sharing platform is configured for receiving at the secure personal data sharing platform, a first user request to store a first user-data item in the verified digital identity; the first user request comprising a first user-data consent to receive and store the first user-data item as part of the verified digital identity on the secure personal data sharing platform. The secure personal data sharing platform may further be configured to in response to receiving the first user request: receiving the first user-data item at the secure personal data sharing platform and optional transmission information for the first user-data item, and processing the first user-data item and optionally the transmission information to determine associated information of the first user-data item, the associated information comprising one or more of sender information, information of certificates and information on encryption and decryption. The first user-data item and the associated information may be stored on the secure personal data sharing platform as part of the verified digital identity. The associated information may determine a verification status of the received first user-data item, the verification status for the first user-data item may include un-verified user-data item or authenticated user data-item. The status of authenticated user-data item may be provided if the determined associated information confirms that the first user data-item is received from an authenticating party being certified for issuing the first user-data item. Access to the user-data items on the secure personal data sharing platform is enabled for third parties upon receipt of second user-data consent; the third parties being informed of the user-data item verification status.

According to some embodiments, a method for securely obtaining and controlling access to a verified digital identity of a user is disclosed. The verified digital identity comprises user-data stored as data items. On a digital personal data sharing platform implemented on an electronic device, the digital personal data sharing platform including a user account comprising the verified digital identity, the method comprises in response to a user request, the user request comprising a user-data consent to receive and store a user-data item as part of the of the verified digital identity on the digital personal data sharing platform, receiving an authenticated user-data item from an authenticating data source, the authenticated user-data item representing the user-data item for which consent was obtained.

According to some embodiments, a system for securely obtaining and controlling access to a verified digital identity of a user is provided. The verified digital identity comprising user-data stored as data items. The system comprises a processor and a storage medium, such as a computer readable storage medium, such as a cloud based storage medium, such as an internet accessible storage medium, such as a server based storage medium. The storage medium is configured to store, and may store, a verified digital identity for a user. The system further comprises a computer program product comprising instructions which when executed by the processor, such as a hardware processor, provides a digital personal data sharing platform, the digital personal data sharing platform including a user account comprising the verified digital identity. The digital personal data sharing platform being configured for in response to a user request, the user request comprising a user-data consent to receive and store a user-data item on the digital personal data sharing platform, receiving an authenticated user-data item from an authenticating data source, the authenticated user-data item representing the user-data item for which consent was obtained.

In some embodiments, in response to receiving the first user request, further receiving transmission information for the first user-data item. The transmission information may be processed along with processing of the first user-data item to determine associated information of the first user data item.

According to some embodiments, a method for securely obtaining or controlling access to a user's authenticated data is disclosed. The method comprises on a digital personal data sharing platform implemented on an electronic device: in response to a user request, receiving an authenticated data item from an authenticating data source; and in response to receiving a permission consent from the user indicating that an institution is allowed access to the authenticated data item, sharing the authenticated data item with the institution.

According to some embodiments, a digital personal data sharing platform for securely obtaining or controlling access to a user's authenticated data is disclosed. The platform may be implemented on an electronic device and is configured for in response to a user request, receiving an authenticated data item from an authenticating data source; and in response to receiving a permission consent from the user indicating that an institution is allowed access to the authenticated data item, sharing the authenticated data item with the institution.

According to some embodiments, a method for securely providing an institution access to authenticated data using a digital personal data sharing platform implemented on an electronic device, is disclosed. The method comprises providing, to the digital personal data sharing platform: a request for sending an authenticated data item from an authenticating data source to a digital personal data sharing platform; and a permission consent indicating that an institution is allowed access to the authenticated data item, and requesting that the platform shares the authenticated data item with the institution.

According to some embodiments, a system to securely obtain and control access to authenticated data from an authenticating data source is disclosed. The system comprises a processor, such as a hardware processor, and a computer readable storage medium, such as a non-transitory computer readable storage medium, storing a computer program product comprising instructions which when executed by the hardware processor provides a digital personal data sharing platform. The digital personal data sharing platform being configured for: in response to a user request, receiving an authenticated data item from an authenticating data source; and in response to receiving a permission consent from the user indicating that an institution is allowed access to the authenticated data item, sharing the authenticated data item with the institution.

According to some embodiments a computer readable storage medium, such as a non-transitory computer readable storage medium, storing a computer program product comprising instructions which when executed by a hardware processor provides a digital personal data sharing platform according to any one of the embodiments.

According to some embodiments, a computer readable storage medium storing a computer program product comprising instructions which when executed by a hardware processor provides a digital personal data sharing platform configured for: receiving an authenticated data item from an authenticating data source in response to a user request; and in response to receiving a permission consent from the user indicating that an institution is allowed access to the authenticated data item, sharing the authenticated data item with the institution.

According to some embodiments, a method for securely obtaining or controlling access to authenticated data from an authenticating data source, the method comprising: receiving an authenticated data item from an authenticating data source in response to receiving a request from a user; and sharing the authenticated data item with one or more institutions according to instructions received from the user.

It is envisaged that the above embodiments, systems and method may be used in any combination. It is further envisaged that the herein disclosed methods may be computer-implemented methods, the methods being implemented using computers, and/or processors, such as hardware processor, configured for performing the methods as herein disclosed.

In some embodiments, the data items may be user-data items, and the user-data items may include user-data items which are unique for the user; user-data items which provides identification for the user, such as user-data items providing proof of identity for the user; user-data items granting particular rights to the user; user-data items providing proof of association, such as proof of ownership; proof of membership; proof of employment; etc.

In some embodiments, the method comprises sharing the user-data items, including authenticated user-data items received from the authenticating party or an authenticating data source with multiple parties, including legal entities, corporations, authorities, such as tax authorities, institutions, such as financial institutions, employers, educational institutions, such as universities, etc.

The secure personal data sharing, i.e. the digital personal data sharing platform, provides a digital tool for securely obtaining one or more authenticated user-data items from an authenticating party or data source and for controlling access to the obtained one or more authenticated data items which can be shared with one or more selected institutions at the user's request and with the user's consent. It is envisaged that the secure personal data sharing platform may comprise both one or more authenticated user-data items and one or more user-data items which are not received from an authenticating data source and thus not an authenticated user-data item.

The authenticated data item, such as the authenticated user-data item, may be shared with the third party, such as the institution, by the third party or institution being allowed to inspect or obtain a copy of the authenticated data item or by the third party or institution receiving confirmation of the existence and/or validity of the data item. For example, if the third party or institution requires confirmation that the user has a valid driver license, the third party or institution may not need to inspect a copy of the license but is contend with a confirmation that the user does in fact have a valid driver license. In other cases, e.g. when the user is a prospect initiating an onboarding process at bank, the bank may require access to a copy of the user's recent wage slips.

The sharing of the user's authenticated data items can be made highly selective such that different institutions have access to different authenticated data items. The authenticated data items may be shared on request of the user or on request of the institution.

The user may provide the request for receiving the authenticated data item from the authenticating data source on the disclosed platform or with the authenticating data source e.g. via a user interface provided on a screen of a client terminal in communication with a system according to an embodiment. Such a user interface can be configured for generally interacting with the platform, e.g. to instruct the platform which institutions should be granted access to which of the user's obtained authenticated data items.

One advantage of the disclosed methods, systems, platforms and computer program products is that a third party or an institution may obtain access to authenticated data items on behalf of the user without the data item passing though the user's computer. Instead the authenticated data item can be directed from the authenticating party or data source to the third party or institution via the secure personal data sharing platform. I.e. in some embodiments, the method comprises instructing the secure personal data sharing platform to obtain an authenticated data item and/or to allow a third party or an institution to gain access to an authenticated data item already on the platform. The user thus determines via his instructions to the platform which data the platform shares with which institution.

In some embodiments, the system and/or the secure personal data sharing platform, i.e. the digital personal data sharing platform, are configured to receive the authenticated user-data item and to share the received authenticated user-data item with an institution in response to instructions provided to the system and/or platform via a user interface displayed on a client terminal.

In some embodiments, the methods may further comprise receiving at the secure personal data sharing platform, a request to verify a user-data item having a status of an un-verified user-data item, in response to receiving the request to verify the un-verified user-data item, sending a verification request from the secure data sharing platform to a verification party, response to receiving third party verification of the un-verified user-data item; processing the third party verification to update associated information of the un-verified user-data item; updating the status of the un-verified user-data item to a verified user data item.

In some embodiments, the secure personal platform may further be configured for receiving at the secure personal data sharing platform, a request to verify a user-data item having a status of an un-verified user-data item, in response to receiving the request to verify the un-verified user-data item, sending a verification request from the secure data sharing platform to a verification party, in response to receiving third party verification of the un-verified user-data item: processing the third party verification to update associated information of the un-verified user-data item; updating the status of the un-verified user to a verified user data item.

In some embodiments, the system and/or the digital personal data sharing platform are configured to receive the user-data items and to share the received user-data items with a third party or an institution in response to instructions provided to the system and/or platform via a user interface displayed on a client terminal.

In some embodiments, at the secure personal data sharing platform, a request may be received to further verify a user-data item having a status of an authenticated user-data item, or a verified user-data item; in response to receiving the request to verify user-data item, a verification request from the secure data sharing platform to a verification party is sent, and in response to receiving third party verification; processing the third party verification to update associated information of the user-data item, and updating the status of the user-data item to a verified user data item.

In some embodiments, a specific user-data item, e.g. a name of a user, may be verified using a plurality of other verified or authenticated user-data items, e.g. a pass port, a drivers licence, a social security, etc.

In some embodiments, the first user request is received by the secure personal data sharing platform and receiving the authenticated user-data item comprises pulling the authenticated user-data item from the authenticating party or data source.

The platform may send a request for the authenticated user-data item to the authenticating third party, or the authenticating data source, in response to an instruction, such as an instruction including a user request and a user consent, received from the user.

In some embodiments, the user request is received by the authenticating party or data source. In response to receiving the user request, the authenticating party or data source may then push the authenticated user-data item to the platform. I.e. in some embodiments, the authenticated data item is received by the platform by means of the authenticating party or data source pushing the authenticated user-data item to the platform.

In some embodiments, the authenticated data item is received by means of the authenticating party or data source providing a token to enable the authenticated data item to be pulled from the authenticating party or data source.

The disclosed methods, systems and platforms can provide that after only one instance of each piece of valid authenticated data item being obtained from the authenticating party or data source to the secure personal data sharing platform, the authenticated data item can be accessed by several third parties, such as by several institutions. This reduces, for example, the effort required by a user to become a customer with multiple institutions.

In some embodiments, the authenticated user-data item received from the authenticating party, upon verification of a second user request comprising a second user-data consent, is made accessible to a third party, the third party being a legal entity.

The disclosed methods, systems and platforms ensures that the authenticity of each piece of user data is an inherent property. This reduces the risk of information fraud and increases the security of the personal data shared with third parties, for example when used to onboard a prospect for a third party or an institution as any information is known to originate from the authenticating party or authenticating data source and be an exact copy of that information. The elimination of subsequent verification steps by the third party or the institution will also have the advantage of reducing the cost of processing and purchasing an additional verification by a verification party, such as a third party verification party. The elimination of a verification step by the institution will also have the advantage of reducing the number of external company interfaces, data transactions and unnecessary exposure of sensitive user data.

The present method and system for managing a verified digital identity of a user, enables communication between parties with a limited exchange of data; while still ensuring that user-data items can be accessed by third parties as needed, upon second user request and second user consent. The user-data items in general may be un-verified, verified or authorized. It is a further advantage of the present invention that by obtaining authenticated user-data items directly from the authenticating party, such as e.g. the authenticating party being certified for issuing the particular user-data item, further authorization, for example by using e.g. a third party verification service, such as using notarization and/or legalization of documents, may be avoided. Thus the present method and systems enables a faster and more efficient access for third parties to authenticated user-data items; that is to user-data items comprising associated information, such as associated information in the form of meta-data, authenticating the user-data item as authenticated, and thus trustable.

It is a further advantage of the present method and systems and the implementation of user-data items in a digital verified identity, wherein the digital verified identity, comprises user data encoded as user-data items, that authenticated user-data items, such as e.g. one set of authenticated user-data items, may be accessed by multiple parties, even without requiring additional authorization steps for subsequent sharing of user-data items.

Some data categories may be required to be resubmitted when the data of the original submission has expired or is no longer correct. For example when a passport, driving license or identity document has expired and been renewed or if there is a change of address.

In the context of the current disclosure, the phrase “prospect” refers to a potential customer of an institution, while the phrase “user” is used in relation to both existing and potential customers. A user, customer or prospect can be an individual person, a society, a company or any entity that could have a legal identity.

The term “institution” can be understood to mean any entity who has subscribed to the method, platform and system as described who would place a request for access to authenticated data of a user. Generally this would be any commercial or non-commercial institution who have potential customers and/or existing customers and who require unique individual information to register the customer as a user. This could be but is not limited to legal entities, financial institutions, insurance companies, legal service providers, betting companies, authorities, educational institutions, etc.

Most commonly, any entity who wishes to onboard a prospect or manage the data access of a customer and ensure the customer has a verified digital identity.

The terms “grant” and “consent” are used interchangeably and are synonymous with each other in the context of this document. A permission may be granted to data which has the same meaning as a consent is given for permission to the data.

A “permission” can be understood in that a permission to the data item is the same as access to the data item. A permission may be granted where access to the data item is given, or a permission may be revoked, in which case access to the data item is either not given or existing access is removed.

The term “transaction” refers to an operation to access data. This may be reading data, writing or both. Examples are submissions of data, data verification requests, data verification responses, consent of permission, revocation of consent of permission, deletion of consent of permission, request for data and so on.

The terms “data”, “data item” and “information” are used interchangeably in the context of this document.

A user may be a costumer and the terms “user” and “customer” are used interchangeably.

In some embodiments, a record of each data transaction is recorded. In some embodiments, a log record is maintained of at least each communication request and response to and from a verification party, each communication request and response to and from authenticating parties, first and second user consents, revocation of first and second user consents, and each data item access by third parties.

An advantage of this is that a full history, such as a full transaction history, is available without undue burden for the purposes of auditing. The method and system can then ensure a standardised practice of obtaining, storing and transaction history logging of required personal data and/or documents and/or communications. This enables regulatory bodies to quickly and efficiently assess the customer data protection compliance of institutions and reduces the need to investigate and test every internal procedure for each individual institution. It also increases the confidence in the accuracy of the data, information and documentation received.

The disclosed methods and a systems still allow a user to create a user owned and controlled verified digital identity for an institution, where elements of the verified digital identity can be reused to create verified digital identities for a plurality of other institutions via their digital personal data sharing platform profile.

In some embodiments, a log record, such as a data transaction record, is written to a provenance enabling system. A “provenance enabling system” is a system that provides data provenance which can be advantageous to employ in the validation of data. A known provenance enabling system may be implemented using block chain technology. Storage of data, such as a authenticated data item, a data transaction record or a user account, can in general be implemented by a computer program product comprising instructions for storing the data on a computer readable storage medium and/or on a provenance enabling system. For the same purpose, the digital personal data sharing platform and/or the system may further be configured for recording a record of each data transaction, and e.g. maintain a log record, and for writing the log record to a provenance enabling system. Each log item of the log record may be written using a hash of the log item. The data can be a hash of the original data or any number of hashes.

An advantage of storing data on a provenance enabling system is that the data cannot be altered. Storing a record of each data transaction thus provides that the full transaction history record is irrefutable and cannot be manipulated, doctored or altered. A verified digital identity can be replicated any number of times and combined with any other combinations of data and stored to the provenance enabling system and attached to any transaction as an irrefutable certificate including personal identification data. All of this may be encrypted and so there is a highly reduced risk to the misuse of any personal data. The user has a simple and single overview of which entities and institutions have access to what personal information and can revoke this access at any time. Logging and recording each data transaction by a provenance enabling system provides that the user's digital identity is highly trustworthy.

Encrypted data may be encrypted to at least a banking grade level, 256-bit AES encryption or similar standard.

An authenticating party may be recognized and approved as an authenticating party using any known implementation; e.g. by providing information about the transmission with the data item, or providing such transmission information prior to receiving the authenticated data item. The transmission information may comprise e.g. sender information, information of certificates and information on encryption and decryption. The sender may be approved as authenticated, e.g. via sender information including specific and prior verified IP addresses, the data item may be encrypted and if decryption is successful at the secure sharing platform, the authenticity of the data item is confirmed. The encryption/decryption may be obtained in any known manner, e.g. using public/private keys, etc. The sender may enclose specific certificates with the transmission information, etc. In some embodiments, transmission information may include information associated with data integrity of data received from the authenticating party and such data may comprise performing a checksum calculation; it may comprise implementing a transport layer protocol, such as a transmission control protocol (TCP), such as a user datagram protocol (UDP), such as a point-to-point tunnelling protocol (PPTP), etc.

The transmission information may contribute to determine associated information of the first user data item, e.g. in the form of updated metadata for the user-data item. The associated information may comprise one or more of sender information, information of certificates and information on encryption and decryption.

In some embodiments, the method comprises: on the digital personal data sharing platform: in response to receiving from the user an input indicating that the institution's permission to access the authenticated data item should be revoked, withdrawing the institutions access to the authenticated data item.

I.e. when the user decides that the institution no longer shall have access to the authenticated data item he/she may provide corresponding instructions to the platform which is configured for, in response to receiving instructions that the institution's permission to access the authenticated data item should be revoked, withdrawing the institutions access to the authenticated data item, subject to applicable laws and regulations.

An advantage of this is that the user has full control over access to their personal data, information and documents and can invoke their right to be forgotten without undue burden. Preferably, an update of information will notify the institution that the information they have is no longer valid and withdraw that information however for the institution to gain access to the new and updated information the customer is required to actively re-consent the permission to the institution. The customer is also notified of the expiry and prompted to reapply the permission consent for the authentic data item to be shared with the requesting institutions. It is a possibility to allow for the information to be automatically updated.

In some embodiments, a permission consent from the user indicating that an institution is allowed access to the authenticated data item on behalf of the user is received, e.g. on the platform. For that purpose the computer program product may comprise instructions for receiving from the user an input indicating that the institution is allowed access to the authenticated data item on behalf of the user.

In some embodiments, the received authenticated data item is stored in a customer digital personal data sharing platform account or profile.

This has the advantage of the authentic data being available to multiple institutions and institutions that may request the information at a later date. The customer is not required to collect the data again and can simply give a permission consent to the requesting institution.

In some embodiments, the user's credentials are verified by the authenticating data source. The advantage of this is that the digital personal data sharing platform is not part of the customer or user verification process by the authenticating data source which leads to an increased security for the customer.

In some embodiments, the first user-data consent may be a time limited consent, and the user-data item is allowed to be received and stored until expiry of the time limit. In some embodiments, the second user-data consent is a time limited consent, and a third party is allowed access to the user-data items with the time limit.

In some embodiments, the authenticated user-data item received from the authenticating party, or data source, has an expiry date, and wherein an updated authenticated user-data item is pushed from the authenticating party to the verified digital identify upon expiry of the authenticated user-data item.

In some embodiments, the authenticated user-data item received from the authenticating party, or data source, has an expiry date, and wherein an updated authenticated user-data item is pulled from the authenticating party to the verified digital identify upon expiry of the authenticated user-data item.

In some embodiments, the authenticated data item received from the authenticating party, or data source, has an expiry date, and wherein the authenticated data item is removed from the verified digital identify upon expiry of the authenticated data item.

In some embodiments, on the secure personal data sharing platform: in response to receiving notice from the authenticating data source that an authenticated user-data item authenticated by the authenticating data source has expired or been invalidated; updating associated information of the authenticated user-data item to include information about the expiry or invalidation to expire or invalidate the authenticated data item from the verified digital identity.

In some embodiments, on the secure personal data sharing platform:

in response to receiving notice from the authenticating party that an authenticated user-data item authenticated by the authenticating party has expired or been invalidated; updating associated information, such as e.g. metadata, of the authenticated user-data item to include information about the expiry or invalidation to expire or invalidate the authenticated data item from the verified digital identity.

In some embodiments, a request for revocation of the first user-data consent is received at the secure personal data platform, and in response to receiving the request for revocation, the authenticated data item is removed from the verified digital identity.

In some embodiments, the method comprises: on the digital personal data sharing platform: in response to receiving notice that the authenticating data source has withdrawn the authenticated data item, withdrawing the authenticated data item from the third party or the institution on behalf of the authenticating party, or authenticating data source.

This may be advantageous when the received authenticated data item is in the form of a license that can be withdraw by the authenticating data source. The authenticated data item can be withdrawn from the institution e.g. by sending a notification to the institution advising or requesting that the institution deletes any downloaded data items or by changing the status of the authenticated data item on the platform. For that purpose, the platform may further be configured for, in response to receiving notice from the authenticating data source expressing that the authenticated data item is withdrawn, withdrawing the data item. An advantage of this is that the institution's confidence in having the most up to date customer data is increased.

The disclosed method, system and computer system has a number of advantages over the prior art in that it provides the customer with:
a more efficient method of supplying an institution with individual data items,
a more secure method of supplying an institution with individual data items,
a simple and auditable method to provide individual data items,
a single place through which to obtain personal data items, to display an overview of available personal data items and to grant or consent permissions and revoke permissions for access by an institution to the personal data,
security by design (encrypted data communication and storage),
privacy by design,
a transparent and simple way to request the right to be forgotten,
ownership of customer personal data,
a user account that can be used multiple times as a legal identity, and
an improved and augmented user experience.

It further provides the institution with:
a simple method in improving the process of onboarding prospects,
the elimination of redundant compliance checks,
irrefutably verified data items from the original data source,
a single point of access of prospect and customer data permission status,
increased security,
security by design (encrypted data communication and storage),
privacy by design,
a means to externalise the customer data responsibility. This reduces the risk of a substantial penalty due to lack of compliance with regulatory requirements, and
an ability to always securely access and handle data required with user permission consents,
a method of managing user data,
a method of managing digital identities,
a method of managing of verified digital identities including user-data items

The method and system also provides a regulatory third party trusted, transparent, auditable and irrefutable access to data transaction history, origin of data, consented permissions, revoked permissions and permissions.

The disclosed methods and systems may find use in several situations as described in the illustratory Examples provided below.

Example 1: A prospect wants to become a customer with a financial institution using a digital personal data sharing platform, i.e. a secure personal data sharing platform, for the collection, verification and storage of the costumer's personal data. As part of onboarding, the financial institution requires access to personal data items of the prospect, including for example an annual tax return. The prospect in this case does not have the required personal data item already accessible on the digital onboarding platform. The prospect thus confirms to the tax authority that the digital personal data sharing platform is to receive a copy of the annual tax return directly and instructs the digital personal data sharing platform to allow the financial institution access to that specific information on the digital onboarding platform.

One benefit of this approach is an increased level of security because the tax document is not transmitted to the computer or device of the prospect, which is considered an unsecure environment. The information does not pass through nor is stored at any stage on the prospect's computer or device and therefore no third party can have accidental or forced access to the data. The authenticity of the data is also guaranteed as being authentic as there is no opportunity that easily allows for document manipulation. Document manipulation is otherwise hard for the institution, such as the legal entity, to detect as it requires the institution, such as the legal entity, having access to the original document and being able to compare the submitted document with the original. A second benefit is an improved user experience because the user or consumer doesn't have to manually download the data from the tax authority and then upload the document to the secure personal data sharing platform.

Allowing the secure personal data sharing platform to obtain the tax document on behalf of the prospect may involve the secure personal data sharing platform interacting with the tax authority customer authentication mechanism in such a way that the secure personal data sharing platform cannot learn the prospect's tax login or user credentials. In such cases, the tax authority will verify the customer credentials as well as the request that the customer wants his tax document transferred to the secure personal data sharing platform. Once verified, the tax authority will either “push” the tax document directly to the costumer profile with the secure personal data sharing platform, or it will give the secure personal data sharing platform an (typically time-limited) access token. This access token is typically time-limited and allows the secure personal data sharing platform the possibility to fetch the tax document via a tax authority API. Either way, the tax document is securely and directly transferred from the tax authority to the customer profile with the secure personal data sharing platform.

Example 2: A user, such as a prospect, would like to collect various personal user-data items on their digital personal data sharing platform profile to enable the data items to be shared with various institutions at a later date. The prospect would e.g. like to add their employment payment slip from the digital storage and distribution system which the employer uses to store and distribute employee payment slips. A user controlled permanent link between the digital personal data sharing platform and in this case the digital storage and distribution system for payslips is established. In the future when an institution, i.e. a legal entity, requires a user or customer pay slip or the last 4 months of user or customer payslips, the user or customer can log on to their secure personal data sharing platform profile and allow the digital storage and distribution system for payslips to push a user defined number or selection of payslips to the requesting institution, i.e. the requesting legal entity. In cases where an institution, i.e. a legal entity, requires a user pay slip or the last 4 months of user payslips, the user can log on to their secure personal data sharing platform profile and allow a user defined number or selection of payslips to be pulled from the digital storage and distribution system for payslips.

Example 3: An institution would like a personal data item such as a customer passport. The method for providing the institution with the passport data directly from the passport issuing authority is the same as described previously. There is an addition in the method as described before as data items such as a passport, driving license, degree certificate etc. can be categorised as being a form of license which can be revoked, lost, stolen, expire or be otherwise withdrawn for any number of reasons. The issuing authority can then revoke or withdrawn the data item. One advantage of this approach is that the data sharing platform will have a record of all of the institutions to which the issued data item has been shared and can easily withdraw or revoke the issued data on behalf of the issuing authority. This also reduces the potential of fraud in that a doctor who has lost their license to practice, person who has forfeited their driving license or any other reasons for a license or document to be withdrawn can be. The institution is then in possession of the correct and most current information on their customers.

Example 4: A customer has won a financial prize through a gambling institution. In most countries taxes of the winnings must be paid and also large financial transactions are flagged and must be explained to the institution receiving the funds for the purposes of anti-money laundering. In order to properly account for the large financial transaction a form of proof is required of where the funds originated as well as to correctly categorise the funds for tax purposes.

The customer can set up a single data item request connection or a recurring data item request connection between their digital gambling profile and their digital personal data sharing platform profile.

When a single data item request is required the customer logs in to his/hers digital gambling profile and authenticate against the digital personal data sharing platform profile. Then a request to push a Proof of Winnings data item from their digital gambling profile to their digital personal data sharing platform profile is submitted. This must be repeated for each Proof of winnings data item required. In their digital personal data sharing platform profile the customer can then allow the tax authority to have access to the Proof of Winnings data item and/or allow the financial institution receiving the prize fund to have access to the Proof of Winnings data item.

When a recurring data item request is required the customer log into his/hers digital gambling profile and authenticate against the digital personal data sharing platform profile. The two profiles are now connected and any number of requests to push a Proof of Winnings data item from their digital gambling profile to their digital personal data sharing platform profile can be submitted. In their digital personal data sharing platform profile the customer can then allow the tax authority to have access to the Proof of Winnings data item and/or allow the financial institution receiving the prize fund to have access to the Proof of Winnings data item.

Other features, embodiments and advantages will be described below in the detailed description.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 shows a flowchart.

FIG. 2 shows a system.

FIG. 3 shows a prior art flow of request and data.

FIG. 4 shows flow of request and data according to some embodiments.

FIG. 5 shows flow of request and data according to some embodiments.

FIG. 6 shows a detailed data flow process with a provenance enabling system.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the scope of the invention as defined by the appended claims.

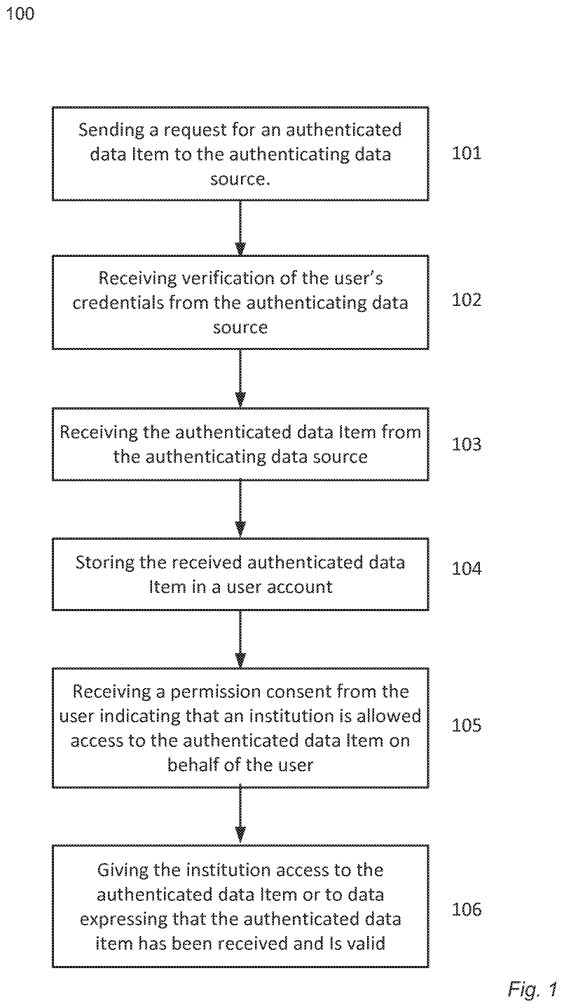

FIG. 1 shows a flow diagram 100 illustrating a method for supplying, via a digital personal data sharing platform, i.e. a secure personal data sharing platform, an authenticated data item from an authenticating data source to a requesting institution in accordance with some embodiments. In step 101, a request for the authenticated data item is sent to the authenticating data source. The request may be provided directly by the user to the authenticating data source or the user may instruct the digital personal data sharing platform to request the authenticated data item from the authenticating data source. The data item may be a user-data item.

In step 102, the user's credentials is verified by the authenticating data source.

In step 103, the secure personal data sharing platform receives the authenticated data item from the authenticating data source, either by the authenticating data source pushing the authenticated data item, by the secure personal data sharing platform pulling the data authenticated data item from the authenticating data source. The authenticated data source may provide a token to enable the authenticated data item to be pulled from the authenticating data source.

In step 104, the received authenticated data item is stored in the user's account on the secure personal data sharing platform.

In step 105, a permission consent is received from the user indicating that an institution, such as a legal entity, is allowed access to the authenticated data item on behalf of the user. In step 106, the requesting institution, such as the requesting legal entity, is provided access to the authenticated data item itself, a representation of this, or to data expressing that the authenticated data item is received by the secure personal data sharing platform and that the authenticated data item is valid.

Each data transaction during the process can be recorded to a provenance enabling system, such as a system implemented using a block chain that is replicated and/or distributed among trusted partners, to form a log of the user's transactions. The log of data transactions can be hashed and stored on the Block chain.

If the user later wish to withdrawn the institution's, such as the legal entity's, access to the authenticated data item this can be done by sending a request to the platform enabling the method. When receiving from the user an input indicating that the institution's permission to access the authenticated data item should be revoked the institutions access to the authenticated data item is withdrawn. The received authenticated data item can also be in the form of a license which can be withdrawn by the authenticating data source.

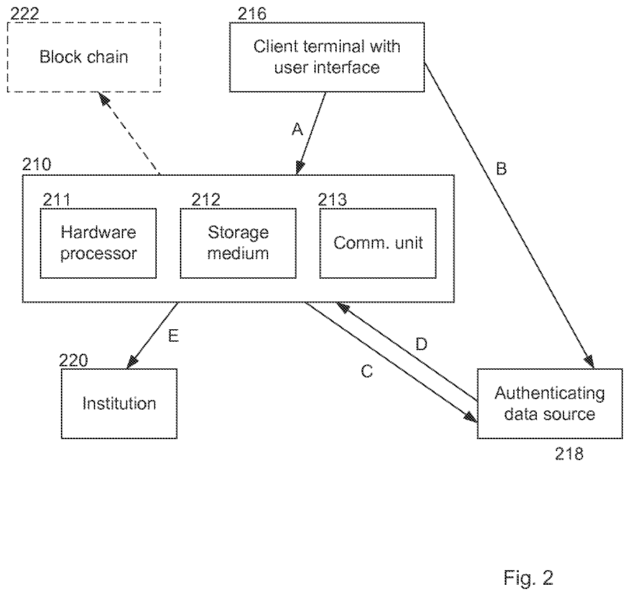

FIG. 2 illustrates how an authenticated data item can be obtained from an authenticating data source and access to this data item can be controlled using a system in accordance with some embodiments. The system 210 comprises a processor 211, such as a hardware processor 211, and a computer readable storage medium 212, such as a non-transitory computer readable storage medium 212, storing a computer program product. The computer program product comprises instructions which when executed by the processor 211 provides a digital personal data sharing platform, i.e. a secure personal data sharing platform, for securely obtaining the authenticated data item from the authenticating data source and for controlling the access to this data item. The system has a communication unit 213 for sending and receiving data to and from external parties, such as authenticating data sources and institutions requesting authenticated data items.

In the illustrated example, the user interact with the system and the authenticating data source via a client terminal 216 on which a user interface is displayed. This interaction can follow different paths depending on whether the user connects to the authenticating data source directly or via the system.

Interacting with the authenticating data source via the system corresponds to following the path defined by arrows A, C and D seen in FIG. 2. When the platform receives a request for obtaining an authenticated data item from the user via the client terminal 216 connected to the communication unit 213 (arrow A), the platform provides that a request for the authenticated data item is sent to the corresponding authenticating data source 218 (arrow C). The request for the authenticated data item is sent and the authenticated data item is received from the authenticating data source 218 (arrow D) via the communication unit 213.

Alternatively, the user can contact the authenticating data source 218 directly (arrow B) requesting that the authenticating data source 218 provides the authenticated data item to the platform on the system 210 (arrow D).

In some cases the authenticating data source 218 requires that the user himself acknowledges that the authenticated data item should be provided to the system. This can be done via arrow A or B in the FIG. 2 such that the process involves data or information flowing along all of paths A-D.

When received, the authenticated data item is written to a user account stored on the storage medium 212 or another storage medium, such as on an external server connected to the system.

The platform is further configured for receiving a permission consent from the user indicating that an institution 220 is allowed access to the authenticated data item on behalf of the user, such that the institution e.g. can download the stored authenticated data item or a confirmation of the existence and validity or the authenticated data item is sent to the institution 220 (arrow E).

In order to provide the user with full control over which institutions or legal entities are allowed access to his/hers authenticated data items, the platform is also configured for withdrawing the institutions access to the authenticated data item in response to receiving instructions from the user to do so. The interaction between the user and the platform can be provided by a user interface displayed on the client terminal 216. The client terminal can be a part of the system or in communicative contact with the system.

In order to maintain track of the user's consents etc. a log of each data transaction initiated by the user, the authenticating data source or the institution, such as the legal entity, can be stored on a provenance enabling system, such as Block chain 222.

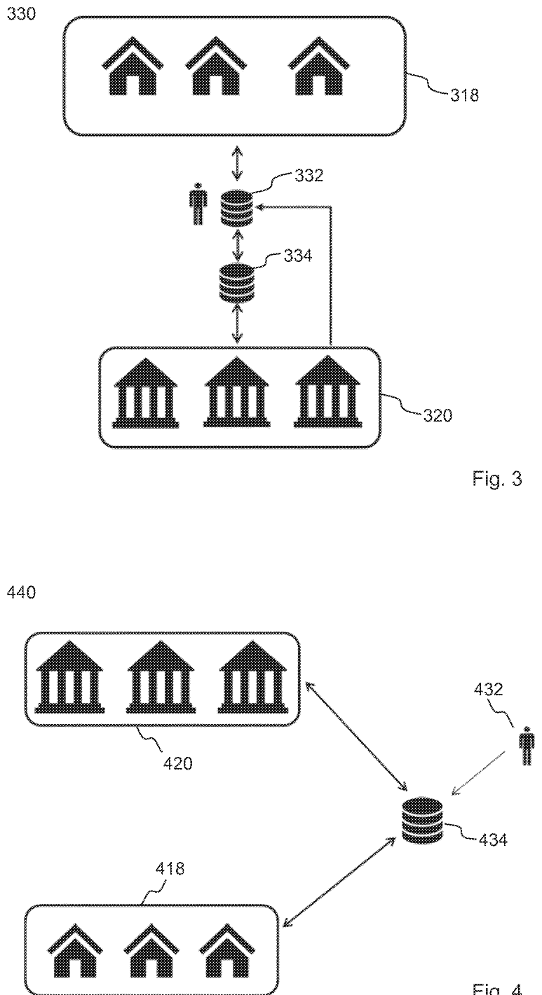

FIG. 3 shows a schematic 330 of the flow of data from authenticating data source to a requesting institution in a prior art system. The institution, or legal entity, 320 sends a request directly to the user or customer 332 or to the user or customer via the secure personal data sharing platform profile 334 for certain items of data. The user or customer 332 either has the data available and at hand, for example a passport copy, or must request the data from the authenticating data source 318, for example the latest tax report would be requested from the tax authority. The authenticating data source 318 provides the customer 332 with the requested data. The customer must save this data on their device, cloud or memory source before uploading it to their digital personal data sharing platform profile 334 and are then able to give the requesting institution 320 access to the requested data held on the customer's digital personal data sharing platform profile.

FIG. 4 shows a diagram 440 illustrating the transfer of request and an authenticated data item in a system according to some embodiments. The institution 420 requiring customer data or documentation sends the request to the customer's profile on the digital personal data sharing platform 434. The digital personal data sharing platform 434 sends a request for the required data to the relevant authenticating data source 418 and awaits the customer's permission consent. The customer 432 logs into their profile at the authenticating data source 418 and approves the sending of the data item to the platform. This can e.g. be done using a digital signature or some other form of secure login. The customer 432 also gives a permission consent that indicates that the platform allows access for an institution 420 to the authenticated data item on behalf of the customer. The authenticated data is then either pulled or pushed from the authenticating data source 418 to the customer's profile on the digital personal data sharing platform 434 and if the customer's permission consent matches the institution 420 who has requested the data the authenticated data item is transmitted to the institution 420. In one embodiment any update to the data can be notified by the authentic data source 418 to the institution 420 directly and a new request by the institution for update authenticated data can be made via the digital personal data sharing platform 434.

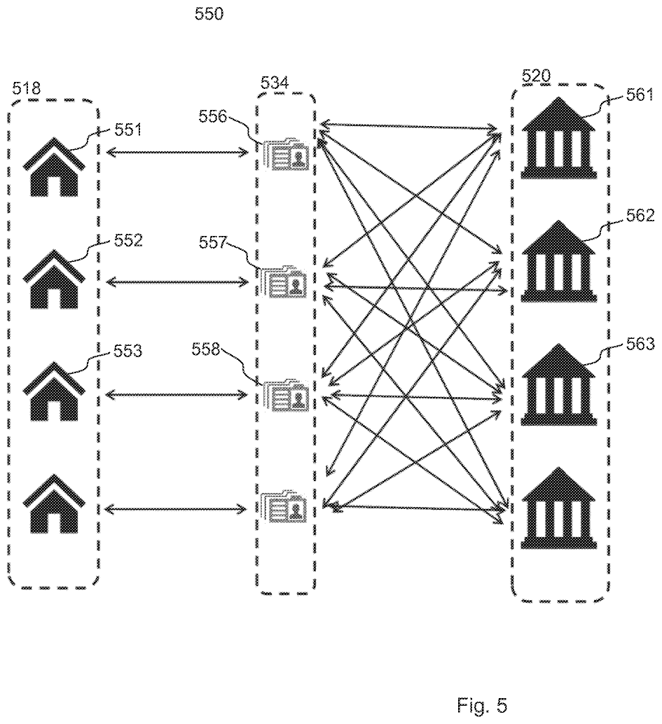

FIG. 5 shows how a group 518 of authenticating data sources pass authenticated data items to the customer's digital personal data sharing platform profile 534 from where the data items are shared with requesting institutions 520. More specifically an individual authenticating data source, or a user authenticating data source, for example a tax authority 551, a passport issuing authority 552 or a gambling company 553 can provide authenticated data items to the customer's or user's digital personal data sharing platform profile 534 where the data items are stored. These data items could be the user's or customer's tax return for last year 556, passport details 557 or proof of winnings 558. The customer is then able to assign permission consents to the various data items and allow the data item to be shared with a group 520 of institutions. The proof of winnings 558 can be shared with for example the tax authority 561 and the user's bank 562. The passport details 557 can be shared with for example the user's bank 562 and their insurance company 563.

A financial institution may also request authenticated data items from the customer's digital personal data sharing platform profile 534. If the authenticated data item is available in the customer's digital personal data sharing platform profile then the customer can assign a permission consent for this particular financial institution. If the authenticated data item is not available in the customer's digital personal data sharing platform profile 534 the customer's digital personal data sharing platform profile can request the data item from the corresponding authenticating data source.

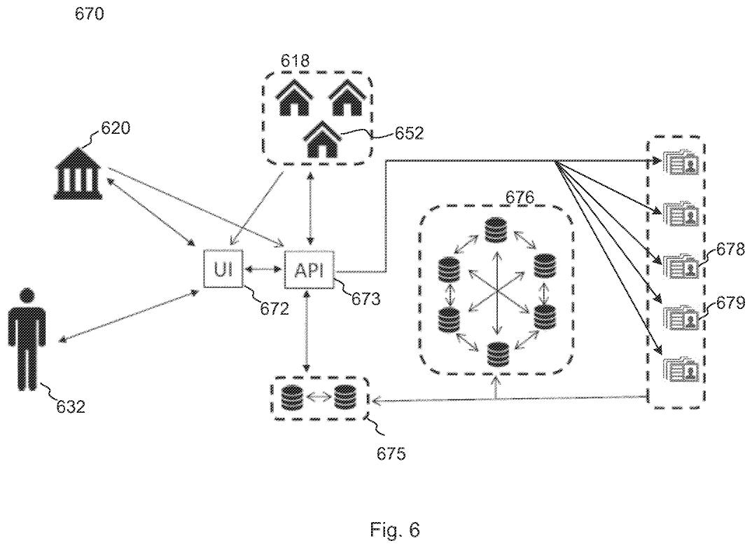

FIG. 6 shows a diagram 670 illustrating the transfer of request and an authenticated data item in a system according to some embodiments in which the customer 632 is logged in via a web interface of the institution or via a direct user interface (UI) 672. The application programming interface (API) 673 receives a request for customer or user-data item from an institution 620, the request is sent to the respective authenticating data source, such as a passport issuing authority 652. The customer or user 632 must log in or identify themselves to the authenticating data source and the authenticated data item is pushed or pulled from the authenticating data source and stored on a computer readable storage medium 675. A record of each request, permission and data transaction is logged and written to a provenance enabled system 676. The record may in be a hash of the data stored or any number of hashes.

The method and system provides the individual institution 620 with irrefutably data items that have been requested from the authenticating and original source 618 and where the user permission consents allow access.

The customer or user 632 can view the data stored at any time via the user interface 672 and chose which institutions 620 have access to which items of data from their unique user account. The same data items can be supplied to multiple institutions depending on the user permission consents present for the data items and the data requested by the institution.

The institution will not receive or have access to any customer or user information that it has not requested and which also has not been approved or given a permission for by the customer or user. The reverse also applies and the user may choose to revoke the permission for individual data items for individual institutions. The institution 620 may send a request for pieces of information and will be granted access to only those where the user has given that institution consent.

The provenance enabling system can be replicated and/or distributed amongst all or some of the participating institutions. Due to the encrypted nature of the information on the provenance enabling system only a specific institution granted a data permission has access to the respective piece of data. The institution can gain access to user consented permission data via a widget or via an API. The method and system thus provides a single source of truth and irrefutable log of data consents and transactions.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

1. A computer-implemented method for managing a verified digital identity of a user, the verified digital identity comprising user-data encoded as user-data items, the verified digital identity being implemented on a secure personal data sharing platform, the secure personal data sharing platform being a network accessible data structure, the secure personal data sharing platform being configured to be accessible by multiple parties; each of the multiple parties having access rights assigned upon second user request and second user consent, the method comprising:
receiving at the secure personal data sharing platform, a first user request to store a first user-data item in the verified digital identity; the first user request comprising a first user-data consent to receive and store the first user-data item as part of the verified digital identity on the secure personal data sharing platform;
in response to receiving the first user request:
receiving the first user-data item at the secure personal data sharing platform, and
processing the first user-data item to determine associated information of the first user data item, the associated information comprising one or more of sender information, information of certificates and information on encryption and decryption;
storing the first user-data item and the associated information on the secure personal data sharing platform as part of the verified digital identity, the associated information determining a verification status of the received first user-data item, the verification status for the first user-data item including un-verified user-data item or authenticated user data-item, wherein the status of authenticated user-data item is provided if the determined associated information confirms that the first user data-item is received from an authenticating party being certified for issuing the first user-data item;
enabling access to the user-data items on the secure personal data sharing platform for third parties upon second user consent; the third parties being informed of the user-data item verification status.

2. A method according to claim 1, further comprising receiving at the secure personal data sharing platform, a request to verify a user-data item having a status of an un-verified user-data item,
in response to receiving the request to verify the un-verified user-data item,
sending a verification request from the secure data sharing platform to a verification party,
in response to receiving third party verification of the un-verified user-data item;
processing the third party verification to update associated information of the un-verified user-data item;
updating the status of the un-verified user-data item to a verified user data item.

3. The method according to any of claims 1-2, wherein the first user request is received by the secure personal data sharing platform and wherein receiving the authenticated user-data item comprises pulling the authenticated user-data item from the authenticating party.

4. The method according to any of claims 1-2, wherein the first user request is received by the authenticating party and wherein the authenticating party in response to receiving the first user request pushes the authenticated data item to the secure personal data sharing platform.

5. A method according to any of the preceding claims, wherein the first user-data consent is a time limited consent, and wherein the user-data item is allowed to be received and stored until expiry of the time limit.

6. A method according to any of the preceding claims, wherein the authenticated user-data item received from the authenticating party, upon verification of a second user request comprising a second user-data consent, is made accessible to a third party, the third party being a legal entity.

7. A method according to any of the preceding claims, wherein the authenticated user-data item received from the authenticating party has an expiry date, and wherein an updated authenticated user-data item is pushed from the authenticating party to the verified digital identify upon expiry of the authenticated user-data item.

8. A method according to any of claims 1-6, wherein the authenticated user-data item received from the authenticating party has an expiry date, and wherein an updated authenticated user-data item is pulled from the authenticating party to the verified digital identify upon expiry of the authenticated user-data item.

9. A method according to any of claims 1-6, wherein the authenticated data item received from the authenticating party has an expiry date, and wherein the authenticated data item is removed from the verified digital identify upon expiry of the authenticated data item.

10. The method according to any of the preceding claims, wherein the method comprises:
on the secure personal data sharing platform:
in response to receiving notice from the authenticating party that an authenticated user-data item authenticated by the authenticating party has expired or been invalidated; updating associated information of the authenticated user-data item to include information about the expiry or invalidation to expire or invalidate the authenticated data item from the verified digital identity.

11. The method according to any of the preceding claims, wherein the authenticated user-data item is received by means of the authenticating party providing a token to enable the authenticated data item to be pulled from the authenticating party.

12. A method according to any of claims 6-11, wherein the method comprises receiving a request for revocation of the first user-data consent, and in response to receiving the request for revocation, removing the authenticated data item from the verified digital identity.

13. A method according to any of the preceding claims, further comprising maintaining a log record of at least each communication request and response to and from a verification party, each communication request and response to and from authenticating parties, first and second user consents, revocation of first and second user consents, and each data item access by third parties.

14. The method according to claim 13, wherein the log record is written to a provenance enabling system.

15. The method according to claim 14, wherein the provenance enabling system is implemented using a block chain, such as a private block chain replicated and/or distributed among trusted partners, wherein each log item is written using a hash of the log item.

16. A method according to any of claims 2-15, further comprising receiving at the secure personal data sharing platform, a request to further verify a user-data item having a status of an authenticated user-data item, or a verified user-data item
in response to receiving the request to verify user-data item,
sending a verification request from the secure data sharing platform to a verification party,
in response to receiving third party verification;
processing the third party verification to update associated information of the user-data item;
updating the status of the user-data item to a verified user data item.

17. A method according to any of claims 2-16, wherein a specific user-data item is verified using a plurality of other verified or authenticated user-data items.

18. A method according to any of the preceding claims, wherein, in response to receiving the first user request, further receiving transmission information for the first user-data item and wherein the transmission information is processed along with processing of the first user-data item to determine associated information of the first user data item.

19. A computer system for managing a verified digital identity of a user,
the system comprising
a processor
a computer readable storage medium storing a computer program product comprising instructions which when executed by the processor provides a secure personal data sharing platform, the secure personal data sharing platform being a network accessible data structure, the secure personal data sharing platform being configured to be accessible by multiple parties;
each of the multiple parties having access rights assigned upon second user request and second user consent; and provides a verified digital identity comprising user-data encoded as user-data items, the verified digital identity being implemented on the secure personal data sharing platform,
the secure personal data sharing platform being configured for:
receiving at the secure personal data sharing platform, a first user request to store a first user-data item in the verified digital identity; the first user request comprising a first user-data consent to receive and store the first user-data item as part of the verified digital identity on the secure personal data sharing platform;
in response to receiving the first user request:
receiving the first user-data item at the secure personal data sharing platform for the first user-data item, and
processing the first user-data item to determine associated information of the first user-data item, the associated information comprising one or more of sender information, information of certificates and information on encryption and decryption;
storing the first user-data item and the associated information on the secure personal data sharing platform as part of the verified digital identity, the associated information determining a verification status of the received first user-data item, the verification status for the first user-data item including un-verified user-data item or authenticated user data-item, wherein the status of authenticated user-data item is provided if the determined associated information confirms that the first user data-item is received from an authenticating party being certified for issuing the first user-data item;
enabling access to the user-data items on the secure personal data sharing platform for third parties upon receipt of second user-data consent; the third parties being informed of the user-data item verification status.

20. A system according to claim 19, wherein the secure personal platform is further configured for receiving at the secure personal data sharing platform, a request to verify a user-data item having a status of an un-verified user-data item,
in response to receiving the request to verify the un-verified user-data item,
sending a verification request from the secure data sharing platform to a verification party,
in response to receiving third party verification of the un-verified user-data item:
processing the third party verification to update associated information of the un-verified user-data item;
updating the status of the un-verified user to a verified user data item.

21. The system according to any of claims 19-20, wherein the secure personal data sharing platform is further configured for maintaining a log record of at least each communication request and response to and from a verification party, each communication request and response to and from authenticating parties, first and second user consents, revocation of first and second user consents, and each data item access by third parties.

22. The system according to claim 21, wherein the log record is written to a provenance enabling system; where the provenance enabling system is implemented in a block chain, such as a private block chain replicated and/or distributed among trusted partners, wherein each log item is written using a hash of the log item.
